(19) United States
(12) Patent Application Publication
(10) Pub. No.: US 2023/0149786 A1
(43) Pub. Date: May 18, 2023

(54) DYNAMIC METHOD AND SYSTEM FOR VIRTUAL REALITY PLAY CALLING AND PLAYER INTERACTIVITY

(71) Applicant: Sports Virtual Training Systems Inc., Colorado Springs, CO (US)

(72) Inventors: Ted Sundquist, Parker, CO (US); Benjamin J. Kwitek, Canon City, CO (US); William Jacob Harris, Littleton, CO (US)

(21) Appl. No.: 18/056,515

(22) Filed: Nov. 17, 2022

Related U.S. Application Data
(60) Provisional application No. 63/264,232, filed on Nov. 17, 2021.

(51) Int. Cl. A63B 69/00; A63B 71/06

(52) U.S. Cl. CPC A63B 69/002; A63B 71/0622; A63B 2243/007; A63B 2071/0638; A63B 2071/0666; A63B 2225/50; A63B 2220/05; A63B 2220/808; A63B 2024/0028

(57) ABSTRACT

A virtual reality system includes a system computer configured to execute computer-executable instructions. The system computer includes a multi-core processor, computer readable non-transitory media storage, and a wireless interface. The virtual reality system also includes a head mounted display device including an immersive display configured to output a first-person view to a player's eye. The virtual reality system further includes a coach's controller configured to execute a coach interface in a coach computer. The coach's controller includes a wireless interface configured to communicate with a wireless interface in the system computer including a multi-core processor. The coach's controller includes a coach console configured to present an opponent play selection interface and team play selection interface. A motion capture tracking system is provided and is linked to the system computer for monitoring movement of a elements of the virtual reality system. The virtual reality system also includes a ball holding device, a play calling subsystem including a playbook database, an interactivity subsystem, and an AI subsystem.

### CROSS REFERENCE TO RELATED APPLICATION

This application claims the benefit of U.S. Provisional Patent Application Ser. No. 63/264,232, entitled “DYNAMIC METHOD AND SYSTEM FOR VIRTUAL REALITY PLAY CALLING AND PLAYER INTERACTIVITY,” filed Nov. 17, 2021, which is incorporated herein by reference.

### BACKGROUND OF THE INVENTION

### 1. Field of the Invention

The invention relates to play calling, play creation, and player interaction in a simulated or virtual reality sports game.

### 2. Description of the Related Art

American football is perhaps the most popular major spectator sport in the United States. Each year from late summer through early winter, millions of Americans watch games and their favorite teams. The National Football League (NFL), along with college and high school teams, significantly contribute to American culture. One only needs to examine the Super Bowl and its astounding numbers regarding audience and impact.

Virtual Reality (VR) or Augmented Reality (AR) systems for playing football provide notable advantages to playing the physical game with other players. This is particularly true for the quarterback. These advantages include: One, the chance for injury is significantly reduced within an indoor environment and without competing players physically chasing, blocking, and tackling the quarterback. More specifically, the chance for concussions and brain injuries is eliminated through the use of VR or AR systems. This is especially relevant given the news of retired players and their struggles with long-lasting negative health side effects from playing football. Two, VR and AR systems allow players to practice for extended periods and encounter various circumstances. Three, amateur or recreational users get the chance to play in an environment that is far more realistic than conventional videos games offered on personal computers and video game consoles.

Sports VTS has created a VR system that utilizes an actual football (which is disclosed in U.S. Patent Application Publication No. 2017/0046967, entitled “VIRTUAL TEAM SPORT TRAINER”, which is incorporated herein by reference).

One of the challenges with existing VR or AR systems for football sports games revolves around the play calling, play interactions, and defensive player responses to the actions of the quarterback. Human players make countless adjustments — either in their minds or with their bodies as each play unfolds. This dynamic interactivity makes the game invigorating. It also makes it difficult to predict winners. As the expression goes, on any given Sunday any team can win.

Existing football video games do not replicate the real scenarios on the field. This is because everything is effectively scripted by programmers at the video game company. While the player at home may control the keypad or joystick, everything occurs within a controlled environment. Plays are known in advance and any adaptation in the video game comes from the human player. Unfortunately, most human players' actions do not proactively change the sequence of events. It is like riding a bike with training wheels. In VR or AR, this level of gameplay is not sufficient to simulate the complexities of the game.

### SUMMARY

It is, therefore, an object of the present invention to provide a virtual reality system implementing virtual reality play calling and player interactivity in the simulation of sports. The virtual reality system includes a system computer configured to execute computer-executable instructions. The system computer includes a processor, computer readable non-transitory media storage, and a wireless interface. The virtual reality system also includes a head mounted display device including an immersive display configured to output a first-person view to a player's eye and a coach's controller configured to execute a coach interface in a coach computer. The coach's controller includes a wireless interface configured to communicate with a wireless interface in the system computer including a multi-core processor. The coach's controller includes a coach console configured to present an opponent play selection interface and team play selection interface. The virtual reality system further includes a motion capture tracking system linked to the system computer for monitoring movement of a elements of the virtual reality system, a ball holding device, and a play calling subsystem including a playbook database.

It is also an object of the present invention to provide a virtual reality system wherein the head mounted display device includes location and direction sensors, a video camera bore-sited to the head mounted display device, and a micro-computer including an image processor that is configured to execute computer instructions.

It is also an object of the present invention to provide a virtual reality system wherein panning of an animated image is performed locally in the head mounted display device and the micro-computer of the head mounted display device is configured as an image processor that receives angular information from the location and direction sensors and selects a portion of an image from an animation module corresponding to a current gaze direction.

It is also an object of the present invention to provide a virtual reality system wherein the head mounted display device includes an audio sensor configured to receive audible play calls made by a player.

It is also an object of the present invention to provide a virtual reality system wherein the audio sensor includes a microphone and an analog-to-digital converter configured to convert the audible play calls to digital data for output to the system computer via wireless interfaces.

It is also an object of the present invention to provide a virtual reality system wherein the play calling subsystem includes a verbal play calling processor linked to a microphone of the head mounted display device and the system computer of the virtual reality system.

It is also an object of the present invention to provide a virtual reality system wherein the verbal play calling processor utilizes voice recognition software to process spoken commands in a simulation, applies a database of spoken words associated with specific plays, and adjusts the simulation accordingly.

It is also an object of the present invention to provide a virtual reality system wherein the verbal play calling processor is also programmed to allow users to control VR simulation with voice commands.

It is also an object of the present invention to provide a virtual reality system wherein the motion capture tracking system includes high-definition cameras.

It is also an object of the present invention to provide a virtual reality system wherein the ball holding device has a predefined geospatial location that is monitored and identified by the motion capture tracking system that is linked to the system computer.

It is also an object of the present invention to provide a virtual reality system wherein the ball holding device has tracking elements allowing for immediate tracking thereof.

It is also an object of the present invention to provide a virtual reality system wherein the playbook database comprises a collection of plays drawn up by coaches and culled from opposing teams.

It is also an object of the present invention to provide a virtual reality system including an interactivity subsystem that includes a database of defensive schemes and a processor automatically adjusting offensive plays and defensive schemes.

It is also an object of the present invention to provide a virtual reality system wherein offensive plays and defensive schemes are adjusted in real-time.

It is also an object of the present invention to provide a virtual reality system including an AI subsystem that includes algorithms allowing defensive assignments and/or alignments to be automated and/or manually generated without having to have extensive knowledge of any defense.

It is also an object of the present invention to provide a virtual reality system wherein the defensive assignments and/or alignments are also updated via ongoing game simulation situations and scenarios.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present virtual reality system for play calling and player interactivity.

FIG. 2 is a perspective view of the present virtual reality system for play calling and player interactivity in use.

### DESCRIPTION

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

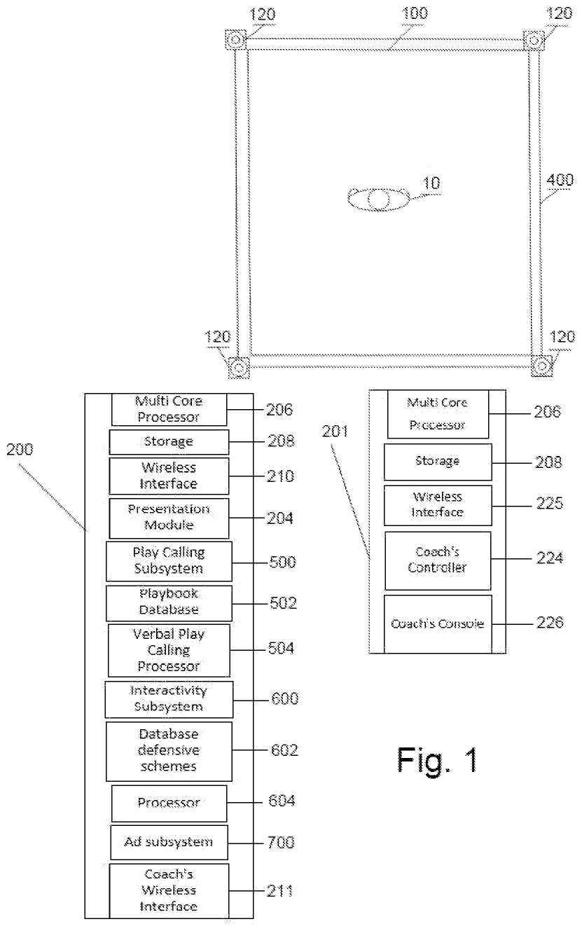

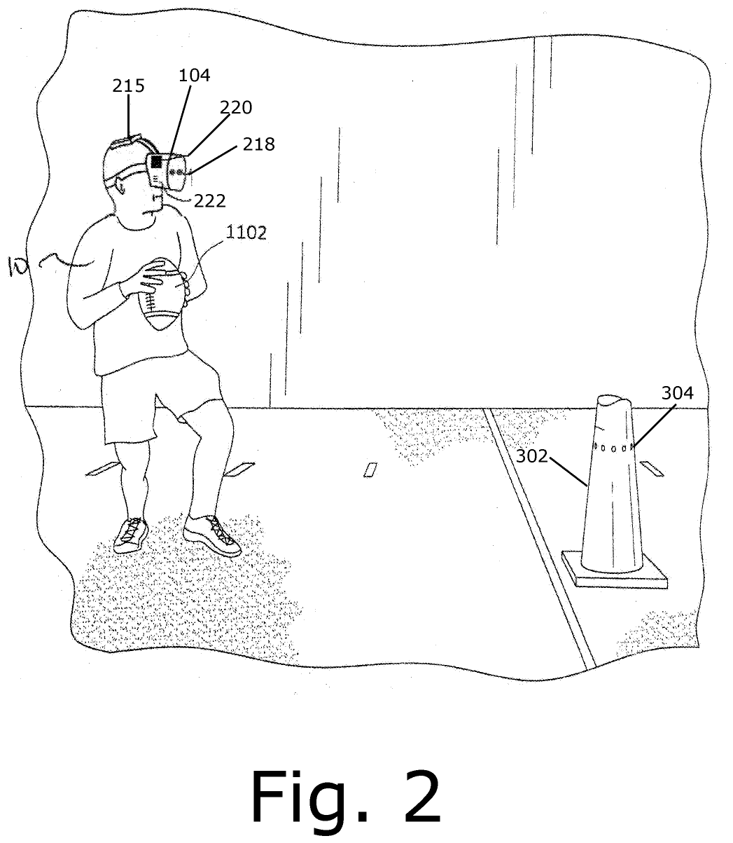

Referring to FIGS. 1 and 2, a virtual reality system 100 implements virtual reality play calling and player interactivity in the simulation of sports. The virtual reality system 100 includes a system computer 200 configured to execute computer-executable instructions. The system computer 200 includes a processor 206, computer readable non-transitory media storage 208, and a wireless interface 210. The virtual reality system 100 also includes a head mounted display device including an immersive display 214 configured to output a first-person view to a player's eye and a coach's controller 224 configured to execute a coach interface in a coach computer 201. The coach's controller 224 includes a wireless interface 225 configured to communicate with a wireless interface 210 in the system computer 200 including a multi-core processor 206. The coach's controller 224 includes a coach console 226 configured to present an opponent play selection interface and team play selection interface. The virtual reality system 100 further includes a motion capture tracking system 400 linked to the system computer 200 for monitoring movement of a elements of the virtual reality system 100, a ball holding device 302, and a play calling subsystem 500 including a playbook database 502. The virtual reality system 100 also includes an interactivity subsystem 600 and an AI subsystem 700.

As will be appreciated based upon the following disclosure, the method and system for virtual reality play calling and player interactivity of the virtual reality system 100 covers three key areas relating to dynamic VR play calling and player interactivity. The first area is playbook simulation. Coaches and analysts spend countless hours drawing up and analyzing plays for every game. This typically occurs while watching “tapes” or recordings of actual games, analyzing the “tapes” or recordings, and applying the information to the development of a game plan. Using recordings of actual games allows the coach to stop the action and witness what specific players did in a real game. Coaches also rely on data and statistics gathered on these games. The data and statistics commonly come from third-party companies such as PFF (Pro Football Focus). Much of this data is gathered manually—that is to say that people watch the games and take notes or record codes for specific actions. Newer technologies are being developed to automatically convert video content into playbooks.

The method and system for virtual reality play calling and player interactivity of the virtual reality system 100 utilizes playbooks to adjust the action within the VR game being presented to the user — allowing real games to be replayed in a virtual environment. As a result, the present method and system for virtual reality play calling and player interactivity allows one to effectively try, in advance of an upcoming game, scenarios and recommendations from coaches and analysts. This is comparable to flight simulators. Flying through a severe thunderstorm is not advisable in a real aircraft, but in an advanced simulator, the pilot learns a lot without any real risk.

One aspect of the present method and system for virtual reality play calling and player interactivity associated with playbook simulation is verbal play calling. The quarterback in the present method and system for virtual reality play calling and player interactivity can speak commands or give verbal indicators that change the actions of his or her players. These commands also impact the defense, as described in greater detail later in the present disclosure. In contrast, and with current VR games, the player with the VR headset must talk to the computer operator to make changes. A coach or third party could also dictate play calling in the simulations, but this is unrealistic, tiresome, and expensive. The present method and system for virtual reality play calling and player interactivity utilizes voice recognition software to process the spoken commands of the quarterback in the simulation. Furthermore, the software of the system for virtual reality play calling and player interactivity is linked to specific databases with programmable keywords. These can be specific to football or even to one team or player. For example, if “Omaha” is uttered by the quarterback, the software knows that this is a signal from the quarterback and not the name of a city in Nebraska. The specialized translator allows players and coaches to talk and work like they would in an actual game.

Another advantage of the verbal play calling associated with the playbook simulation component of the present method and system for virtual reality play calling and player interactivity relates to recreational players. The system for virtual reality play calling and player interactivity allows a player to control the game with voice commands. This eliminates the need for a computer operator at the venue. This also lowers the costs for entertainment venues as simulation systems integrating the present method and system for virtual reality play calling and player interactivity would be virtually autonomous—with guidance for the player (customer). It also allows the player to compete without removing their headset and creates another sensory input for the participant as well as observers or fans in the venue.

A second aspect of the playbook simulation feature associated with the method and system for virtual reality play calling and player interactivity is automatic play creation. Those associated with the method and system for virtual reality play calling and player interactivity observe the improvisational moves of the quarterback and document these in the form of actual plays or playbooks. This could also occur in reverse as described earlier. Recorded plays are entered into the system for virtual reality play calling and player interactivity for realistic simulation. This may even be possible without any human analysis or coding. The raw video footage is machine coded using smart object identification software. This allows coaches to save time and test more sample plays—all in the safety of a VR world.

A third aspect of the playbook simulation associated with the method and system for virtual reality play calling and player interactivity is training. Potential draft picks or recruits are placed into simulations that offer more experiential learning than watching previous games or asking questions. For example, a candidate quarterback for Alabama could be placed into a real game versus LSU. This VR experience would give the coaches a chance to see how a player fits on their team. It also shows how the player matches up with current players—all based on actual data and plays recorded from real games. It also gives coaches a chance to work on the weaknesses of a new draft pick before the player ever steps foot on the field.

The second area relating to a dynamic virtual reality play calling and player interactivity in accordance with the present invention is offense and defense interactivity. Newton's Third Law in physics about actions having reactions is applicable here. As applied in accordance with the present system, if the quarterback moves from shotgun to the line, the defense will naturally react in an actual game without coaching. Shifts and Motions are an integral part of any offensive system at any level; High School, College, or Pro. The general strategy is to move your offensive personnel (those eligible to move forward/backward and or side/side), either prior to or at the snap of the football to create an advantage over the alignment of the defensive personnel. The defense can be expected to respond with their own counter movement and are not limited to specific personnel, but rather all defenders can reposition their original alignment (either individually or in multiple player scenarios). Often the defense can be found to initiate the first movement in order to confuse, disguise, or create their own advantage at the snap of the ball.

In the VR simulation created in accordance with the present method and system for virtual reality play calling and player interactivity the same events and actions happen. The quarterback's location and the ball location impact defensive formations and actions. Perhaps even the direction of the quarterback's head or eyes initiates defensive responses. This data is gathered through the use of the overhead cameras and other sensors—familiar to those skilled in the art.

This interactivity with the defense created in accordance with the present method and system for virtual reality play calling and player interactivity sets a new standard for VR simulation. The formations and actions are no longer canned scripts from a programmer's mind. The virtual game becomes real as actions promote reactions. This increases the complexity of the simulation by leaps and bounds. This enhanced complexity mimics actual scenarios on football fields. It is Artificial Intelligence (AI) for the game.

The third area relating to dynamic virtual reality play calling and player interactivity created in accordance with the present method and system for virtual reality play calling and player interactivity is defensive artificial intelligence (AI). This allows defensive assignments and alignments to be automated (using real game data) and/or manually generated without having to have extensive knowledge of any defense. The assignments/alignments are also updated via ongoing game simulation situations and scenarios. The programming for this defensive AI is built with the proper alignment/assignment rules already in place. Therefore, it ensures that defenders are aligned in the proper position on the field with regard to their responsibility (coverage, gap, blitz gap, etc.) as well as their drop depths and positional leverage (inside, center, outside). The system for virtual reality play calling and player interactivity also employs connecting links to defensive personnel packages, fronts, and coverages. These are stored as the origins for the “basics” for each of those elements of a defensive play call. Changes are made outside of these original aspects to allow for creative thoughts on the fly and without making wholesale changes to fundamentals, or inadvertently making a subtle change and forgetting to edit back to the original state within the defensive playbook.

Shift and Motion are similar and yet entirely different challenges given the current status of starting a play with the simulated snap. Shift can be best defined by the movement of skilled position players (X, Y, Z, H, F, and QB) from one set position in a given formation, into an alternate set position that creates an alternate version of, or entirely different formation. The associated play can either be a varied form of the original or an entirely different play associated with the new formation created as a result of the shift. Individual or multiple players can be moving at the same time within a shift, as long as all reset into their new position for a single count.

Motion is similar to shift in that a player is repositioning with movement to create a new formation but is actually moving at the simulated snap (as long as the movement is parallel and not towards the line of scrimmage when considered in the context of American football). Unlike shifts, only one offensive player may be in a motion at the time of the simulated snap and that player must be one of the four set behind the line of scrimmage. No player on the line of scrimmage may be in motion at the time of the simulated snap. Violation of this rule is a five-yard penalty and the play is often immediately stopped by the officials. The present method and system for virtual reality play calling and player interactivity ensures these football fundamentals are carefully observed—again allowing for a realistic simulation.

In practice, the present system for virtual reality play calling and player interactivity records every movement and play. The present system for virtual reality play calling and player interactivity then conducts a cause-and-effect analysis. The analysis provides the present system for virtual reality play calling and player interactivity with recommendations for better plays—on the offensive and defensive sides. With regard to defense, this AI will continuously improve. The players in the virtual game as generated by the present system for virtual reality play calling and player interactivity will get smarter—much like humans in the physical game. This provides effective training for quarterbacks that does not become irrelevant or outmoded. The quarterback never “grows out” of the proposed simulation because it grows with him or her.

The AI play calling associated with the present method and system for virtual reality play calling and player interactivity also gives coaches the chance to simulate improving opponents or opponents who do the unexpected. With each simulation, more data is collected. Eventually, the quantity of data allows for incredible results. It is analogous to the million monkeys with keyboards—eventually, they recreate the works of Shakespeare.

The AI play calling associated with the present method and system for virtual reality play calling and player interactivity is also a significant benefit to recreational players. It might now be impossible to “conquer” a game as the game always gets harder. This makes the challenge even more enticing as there is no limit baked into the code. It allows for entertainment that continues to expand. The catalog of existing plays grows and evolves with every play.

It is also envisioned that all of the VR simulators could be linked. This linkage would allow data to be saved to the cloud or remote and interconnected servers. A player in Michigan might be making the game harder for a player in Texas—all in real-time.

With the foregoing in mind, an embodiment of the present method and system for virtual reality play calling and player interactivity is disclosed as the virtual reality system 100 for simulating sports disclosed with reference to FIGS. 1 and 2. The virtual reality system 100 is a team sport trainer providing psychological and physiological training. The virtual reality system 100 disclosed herein includes the components generally as described in Applicant's own system for simulating sports as disclosed in U.S. Patent Application Publication No. 2017/0046967, entitled “VIRTUAL TEAM SPORT TRAINER”, and U.S. Provisional Patent Application Ser. No. 63/174,925, entitled “VIRTUAL REALITY TRANSLATION OF LOCATION BASED ON STARTING POSITION OF SPORTS IMPLEMENT,” both of which are incorporated herein by reference, while also integrating the play calling and player interactivity as contemplated in accordance with the present invention.

The virtual reality system 100 provides training and recreation by accurately simulating the real play against an opponent team 12. The virtual reality system 100 provides first person perspective and feedback intended to hone reactive instincts between mind-body connections as a result of seeing a visual stimulus and reacting with a physical response to the stimulus. The virtual reality system displays to the player 10 the offensive and defensive plays within the field of view as provided via a head mounted display device 104. The virtual reality system 100 also detects the trajectory and responsively of a real football 1102 and animates a simulated pass according to the velocity and angle of release of the real football 1102. The animated pass can then be displayed to the player 10 via the head mounted display device 104, allowing the player 10 to watch the path of the virtual football to the simulated receiver 14, along with a simulated reaction of the opponent team 12 to the throw.

FIG. 1 is a block diagram schematic showing a hardware arrangement for presenting an immersive team sport training environment to a player 10, according to the virtual reality system 100 for simulating sports. The virtual reality system 100 includes computer-executable instructions, corresponding to software modules described below, carried by a non-transitory computer-readable medium.

In particular, the virtual reality system 100 includes a system computer 200 configured to execute at least a portion of the computer-executable instructions. The system computer 200 includes, in addition to other components commonly found in computers, a multi-core processor 206, a computer readable non-transitory media storage 208, and a wireless interface 210. The system computer 200 is configured to execute at least a portion of the computer-readable instructions described herein.

The head mounted display device 104 (mentioned above) includes an immersive display 214 configured to output the first-person view to the player's eye 202. The head mounted display device 104 includes location and direction sensors 216 (or a real-time location tracker and a real-time gaze tracker). The head mounted display device 104 further includes a video camera 218 bore-sited to the occluded head mounted display device 104 (that is, the video camera 218 is centered in conjunction with the head mounted display device 104). The head mounted display device 104 also includes a micro-computer 220 including an image processor. The micro-computer 220 is configured to execute computer instructions corresponding to a presentation module 204 of the software (described below).

It is important for gaze direction to be properly registered to the player's head movements. A perceptible lag in panning of the immersive image relative to the real direction of the player's head can be distracting and/or can induce motion sickness. In one embodiment, panning of the animated image is performed locally, in the head mounted display device 104. The local micro-computer 220 of the head mounted display device 104 is configured as an image processor that receives angular information from the location and direction sensors 216 and selects a portion of the image from the animation module corresponding to the current gaze direction.

The head mounted display device 104 further includes an audio sensor 222 configured to receive audible play calls made by the player. The audio sensor 222 includes a microphone and an analog-to-digital converter configured to convert the audible play calls to digital data for output to the system computer 200 via wireless interface 215 of the head mounted display device 104.

The virtual reality system 100 further includes a coach's controller 224 configured to execute a coach interface in a coach computer 201. The coach's controller 224 includes a wireless interface 225 configured to communicate with the coach's wireless interface 211 in the system computer 200 including a multi-core processor 206. The coach's controller 224 includes a coach console 226 configured to present an opponent play selection interface and team play selection interface.

In addition, and as will be appreciated based upon the following disclosure, the virtual reality system 100 also includes a motion capture tracking system 400 that is linked to the system computer 200 for monitoring movement of the football 1102 and other elements of the system. Once airborne, the location of the football 1102 is tracked by the motion capture tracking system 400, which includes high-definition cameras 120 and the accompanying software that provides a realistic simulation for the user.

The present invention utilizes a ball holding device 302 in the form of a cone or other holding device to set the initial position of the football 1102. It should be noted that holding devices of other shapes and devices may be employed without departing from the spirit of the invention. The ball holding device 302 may also be used to place or hold the football 1102.

In accordance with a disclosed embodiment, the ball holding device 302 has a predefined geospatial location (x, y, and z Cartesian coordinates) that is monitored and identified by the motion capture tracking system 400 that is linked to the system computer 200 discussed above. In accordance with a disclosed embodiment, the OptiTrack™ motion capture tracking system is used and the specifications for the cameras 120 of the OptiTrack™ motion capture tracking system 400 are implemented. However, it is appreciated the cameras can be any type of device which can capture and convert a digital signal to the horizontal and vertical locations of the ball holding device 302 within the view of the IR (Infrared) motion tracking camera 120. The ball holding device 302 has tracking elements 304 allowing for immediate tracking thereof, for example, the tracking elements may be IR LEDs that may be identified by the motion capture tracking system 400. While IR LEDs 304 are disclosed in accordance with this embodiment, the tracking elements could be other LEDs (Light Emitting Diodes), RFID (Radio-frequency Identification), NFC (Near-field Communication), GPS (Global Position System), or other location tracking technologies such as triangulation.

As a result of the motion capture tracking system 400 identifying the starting location of the football 1102, the ball holding device 302 may be repositioned where desired. This repositioning automatically causes the software to redraw the animated field 30 based on the new perceived location. This allows for new plays and the optimal use of the physical practice field 106 space within the training or entertainment venue.

This geospatial creation is accomplished with various calculations and formulas—including algorithms to maximize beneficial effects in the simulation. Once a play has commenced, the virtual location of the player is always started relative to that of the ball holding device 302. The offset of the physical location of the ball holding device 302 at the start of the play serves as a fiduciary location to provide the necessary motion tracking offsets such that virtual translation of motion occurs in a meaningful way. By allowing the user to manually position the ball holding device 302 before starting a play, the user can optimize the use of the physical area of the motion capture equipment without having to recalibrate or reset the origin for motion tracking. This also provides an intuitive method for the user to adjust the simulation's origin for motion tracking of the player. The software may also employ machine learning techniques to create AI-inspired scenarios, histories, and the like.

The operational components of the previously described method and system for virtual reality play calling and player interactivity are integrated with system computer 200 described above to add the functionality of the method and system for virtual reality play calling and player interactivity to VR systems disclosed in U.S. Patent Application Publication No. 2017/0046967, entitled “VIRTUAL TEAM SPORT TRAINER,” and U.S. patent application Ser. No. 17/659,137 (which claims the benefit of U.S. Provisional Patent Application Ser. No. 63/174,925), entitled “VIRTUAL REALITY TRANSLATION OF LOCATION BASED ON STARTING POSITION OF SPORTS IMPLEMENT,” which are incorporated herein by reference. As such a play calling subsystem 500, an interactivity subsystem 600, and an AI subsystem 700 are integrated into the system computer 200 of the virtual reality system for simulating sports 100?.

The play calling subsystem 500 includes a playbook database 502 composed of a collection of plays drawn up by coaches and culled from opposing teams. Through the application of the plays collected in the playbook database 502 the play calling subsystem 500 allows real games to be replayed in a virtual environment permitting one to effectively try, in advance of an upcoming game, scenarios and recommendations from coaches and analysts.

The play calling subsystem 500 also includes verbal play calling processor 504 linked to the microphone of the audio sensor 222 of the head mounted display device 104 and the system computer 200 of the virtual reality system 100. The verbal playing calling processor 504 utilizes voice recognition software to process the spoken commands of the quarterback in the simulation, apply a database of spoken words 506 associated with specific plays, and adjust the VR simulation accordingly. The verbal play calling processor 504 is also programmed to allows users to control VR simulation with voice commands, thus eliminating the need for a computer operator at the venue.

The play calling subsystem 500 also provides for automatic play creation based upon the movements of the user and training based upon desired goals.

The interactivity subsystem 600 includes a database of defensive schemes 602 and processor 604 automatically adjusting the offensive plays and defensive schemes in real-time and based upon the user of the virtual reality system 100. For example, and as explained above, if the quarterback moves from shotgun to the line, the defense will naturally react in an actual game without anyone coaching.

The AI subsystem 700 includes algorithms allowing defensive assignments and alignments to be automated (using real game data) and/or manually generated without having to have extensive knowledge of any defense. The assignments/alignments are also updated via ongoing game simulation situations and scenarios.

Those skilled in the art will appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall tracking and management system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine.

The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard-wired network cable such as Ethernet or may be a wireless connection such as an RF link running under a wireless protocol such as 802.11.

The computer system can also have a user interface port that communicates with a user interface, which receives commands entered by a user, and a video output that produces its output via any kind of video output format, e.g., VGA, DVI, HDMI, display port. This may include laptop or desktop computers, and may also include portable computers, including cell phones, smartphones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations, using tangible computer programming. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non-transitory computer-based instructions. An exemplary storage medium is coupled to the processor such that the processor can read information from, and write information to, the storage medium. In the alternative, the storage medium may be integral to the processor. The processor and the storage medium may reside in reconfigurable logic of any type.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew, or any other programming language. The programs may be resident on a storage medium, e.g., magnetic or optical. The storage medium may take the form of a computer hard drive, a removable disk or media such as a memory stick or SD media, or other removable medium. The programs may also be run over a network, for example, with a server or other machine sending signals to the local machine, which allows the local machine to carry out the operations described herein.

While the preferred embodiments have been shown and described, it will be understood that there is no intent to limit the invention by such disclosure, but rather, is intended to cover all modifications and alternate constructions falling within the spirit and scope of the invention.

1. A virtual reality system implementing virtual reality play calling and player interactivity in the simulation of sports, comprising:
a system computer configured to execute computer-executable instructions, the system computer includes a processor, computer readable non-transitory media storage, and a wireless interface;
a head mounted display device including an immersive display configured to output a first-person view to a player's eye;
a coach's controller configured to execute a coach interface in a coach computer, the coach's controller includes a wireless interface configured to communicate with the wireless interface in the system computer, the coach's controller includes a coach console configured to present an opponent play selection interface and team play selection interface;
a motion capture tracking system linked to the system computer for monitoring movement of a elements of the virtual reality system;
a ball holding device; and
a play calling subsystem including a playbook database.

2. The virtual reality system according to claim 1, wherein the head mounted display device includes location and direction sensors, a video camera bore-sited to the head mounted display device, and a micro-computer including an image processor that is configured to execute computer instructions.

3. The virtual reality system according to claim 2, wherein panning of an animated image is performed locally in the head mounted display device and the micro-computer of the head mounted display device is configured as an image processor that receives angular information from the location and direction sensors and selects a portion of an image from an animation module corresponding to a current gaze direction.

4. The virtual reality system according to claim 2, wherein the head mounted display device includes an audio sensor configured to receive audible play calls made by a player.

5. The virtual reality system according to claim 4, wherein the audio sensor includes a microphone and an analog-to-digital converter configured to convert the audible play calls to digital data for output to the system computer via wireless interfaces.

6. The virtual reality system according to claim 5, wherein the play calling subsystem includes a verbal play calling processor linked to a microphone of the head mounted display device and the system computer of the virtual reality system.

7. The virtual reality system according to claim 6, wherein the verbal play calling processor utilizes voice recognition software to process spoken commands in a simulation, applies a database of spoken words associated with specific plays, and adjusts the simulation accordingly.

8. The virtual reality system according to claim 7, wherein the verbal play calling processor is also programmed to allow users to control VR simulation with voice commands.

9. The virtual reality system according to claim 1, wherein the motion capture tracking system includes high-definition cameras.

10. The virtual reality system according to claim 1, wherein the ball holding device has a predefined geospatial location that is monitored and identified by the motion capture tracking system that is linked to the system computer.

11. The virtual reality system according to claim 10, wherein the ball holding device has tracking elements allowing for immediate tracking thereof.

12. The virtual reality system according to claim 1, wherein the playbook database comprises a collection of plays drawn up by coaches and culled from opposing teams.

13. The virtual reality system according to claim 1, further including an interactivity subsystem that includes a database of defensive schemes and a processor automatically adjusting offensive plays and defensive schemes.

14. The virtual reality system according to claim 13, wherein offensive plays and defensive schemes are adjusted in real-time.

15. The virtual reality system according to claim 1, further including an AI subsystem that includes algorithms allowing defensive assignments and/or alignments to be automated and/or manually generated without having to have extensive knowledge of any defense.

16. The virtual reality system according to claim 15, wherein the defensive assignments and/or alignments are also updated via ongoing game simulation situations and scenarios.
